(19) United States
(12) Patent Application Publication
(10) Pub. No.: US 2025/0190021 A1
(43) Pub. Date: Jun. 12, 2025

(54) FOLDABLE ELECTRONIC APPARATUS

(71) Applicant: SYNCMOLD ENTERPRISE CORP., New Taipei City (TW)

(72) Inventors: Ching-Hui Yen, New Taipei City (TW); Yu-Shian Liu, New Taipei City (TW); Ya-Hui Chen, New Taipei City (TW)

(21) Appl. No.: 18/921,054

(22) Filed: Oct. 21, 2024

Related U.S. Application Data
(60) Provisional application No. 63/607,236, filed on Dec. 7, 2023.

(30) Foreign Application Priority Data
Jul. 31, 2024 (TW) 113128543

(51) Int. Cl. G06F 1/16

(52) U.S. Cl. CPC G06F 1/1641

(57) ABSTRACT

A foldable electronic apparatus is provided and comprises a base unit and a display unit. The display unit includes: a main panel body having a first side and a bottom side perpendicular to each other, in which the bottom side is connected to the base unit; a first folding module provided on the first side and having at least one first encoding unit; a first side panel body provided on the first folding module; and a flexible screen including a main display area and a first side display area. The first encoding unit is used to detect a first angle between the main panel body and the first side panel body, and display states of the main display area and the first side display area are switched by the foldable electronic apparatus according to the first angle.

### CROSS-REFERENCE TO RELATED APPLICATIONS

This application claims the benefit of U.S. Provisional Application Ser. No. 63/607,236 filed on Dec. 7, 2023, and the benefit of Taiwan Patent Application Serial No. 113128543 filed on Jul. 31, 2024. The entirety of each application is incorporated herein by reference.

### BACKGROUND

### 1. Technical Field

The present disclosure relates to a foldable electronic apparatus, and more particularly, to a foldable electronic apparatus capable of switching between different display states according to angles between multiple screens.

### 2. Description of Related Art

In recent years, an electronic apparatus capable of folding screen has become more and more common. However, although the existing foldable screens are multiple that can be folded with each other, the state of each screen in different folding modes is mostly manually operated. Also, the existing foldable screens cannot be switched between different display states based on the angles between multiple screens, which is very inconvenient for users.

### SUMMARY

The present disclosure provides a foldable electronic apparatus provided on a work surface, the foldable electronic apparatus comprises: a base unit provided on the work surface; and a display unit including: a main panel body having a first side and a bottom side substantially perpendicular to each other, wherein the bottom side is connected to the base unit; a first folding module provided on the first side and having at least one first encoding unit; a first side panel body provided on the first folding module and capable of rotating relative to the main panel body about the first folding module as an axis; and a flexible screen provided on the main panel body, the first folding module and the first side panel body and including a main display area and a first side display area, wherein the main display area corresponds to the main panel body, and the first side display area corresponds to the first side panel body, wherein the first encoding unit is used to detect a first angle between the main panel body and the first side panel body, and display states of the main display area and the first side display area are switched by the foldable electronic apparatus according to the first angle.

In the aforementioned foldable electronic apparatus, the display unit further includes a second folding module and a second side panel body, the main panel body further has a second side opposite to the first side, and the second folding module is provided on the second side and has at least one second encoding unit, wherein the second side panel body is provided on the second folding module and capable of rotating relative to the main panel body about the second folding module as an axis, wherein the flexible screen further includes a second side display area, and the second side display area corresponds to the second side panel body, wherein the second encoding unit is used to detect a second angle between the main panel body and the second side panel body, and display states of the main display area and the second side display area are switched by the foldable electronic apparatus according to the second angle.

In the aforementioned foldable electronic apparatus, the main display area, the first side display area and the second side display area are in a display state of being off when the first angle and the second angle are both 0 degrees.

In the aforementioned foldable electronic apparatus, the main display area is in a display state of being on and the first side display area and the second side display area are in a display state of being off when the first angle and the second angle are both about 95 degrees.

In the aforementioned foldable electronic apparatus, the main display area, the first side display area and the second side display area are in a display state of being on and capable of displaying different program images respectively when the first angle and the second angle are both about 135 degrees.

In the aforementioned foldable electronic apparatus, the main display area, the first side display area and the second side display area are in a display state of being on and capable of displaying continuous images of same program when the first angle and the second angle are both about 180 degrees.

In the aforementioned foldable electronic apparatus, the first encoding unit and the second encoding unit are angle encoders, axis encoders, or rotary encoders.

In the aforementioned foldable electronic apparatus, the base unit has a processor, and the first encoding unit and the second encoding unit respectively transmit detection results of the first angle and the second angle to the processor.

In the aforementioned foldable electronic apparatus, the base unit is a detachable external keyboard when the display unit is a foldable tablet computer, and the base unit is a laptop host or a screen support frame when the display unit is a display screen.

In the aforementioned foldable electronic apparatus, the first folding module or the second folding module further has a central base, a torque member, a left wing member, a left transmission member, a left carrying member, a right wing member, a right transmission member, a right carrying member and a synchronization member, wherein the first encoding unit or the second encoding unit is provided on the left transmission member or the right transmission member.

In the aforementioned foldable electronic apparatus, a width of the main panel body is equal to a sum of a width of the first side panel body and a width of the second side panel body.

As can be understood from the above, the foldable electronic apparatus of the present disclosure is capable of detecting the folding conditions of the first side panel body and the second side panel body relative to the main panel body by the first encoding unit and the second encoding unit, respectively, and can be automatically switched between different display states according to different angles without switching through a keyboard or other controllers, which is convenient to use and provides a good using experience.

### BRIEF DESCRIPTION OF THE DRAWINGS

FIG. 1 is an overall schematic diagram of the foldable electronic apparatus of the present disclosure.

FIG. 2 is an exploded schematic diagram of the foldable electronic apparatus of the present disclosure.

FIG. 3 is an exploded schematic diagram of the first folding module/second folding module in the foldable electronic apparatus of the present disclosure.

FIG. 4 is a schematic diagram of the foldable electronic apparatus of the present disclosure of which the main panel body is in a display state of being on, and the first side panel body and the second side panel body are in a folded state.

FIG. 5 is a schematic diagram of the foldable electronic apparatus of the present disclosure of which the main panel body is in a display state of being on, and the first side panel body and the second side panel body are in a semi-open state.

FIG. 6 is a schematic diagram of the foldable electronic apparatus of the present disclosure of which the main panel body is in a display state of being on, and the first side panel body and the second side panel body are in a fully open state.

FIG. 7 is an overall schematic diagram of another embodiment of the foldable electronic apparatus of the present disclosure.

### DETAILED DESCRIPTION

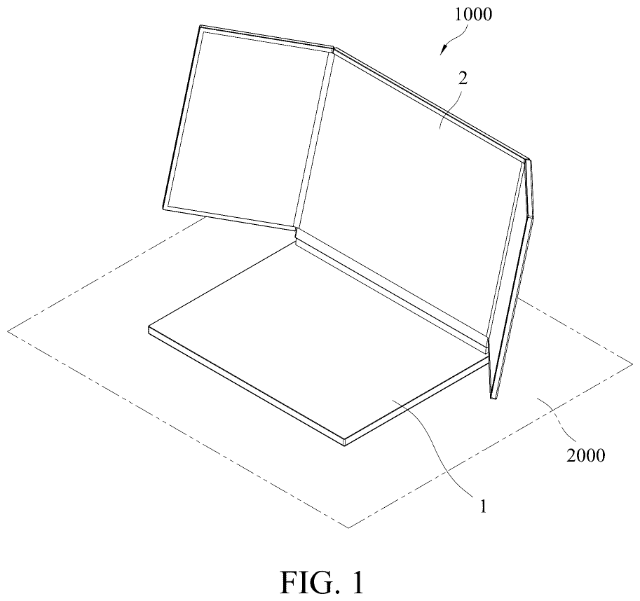

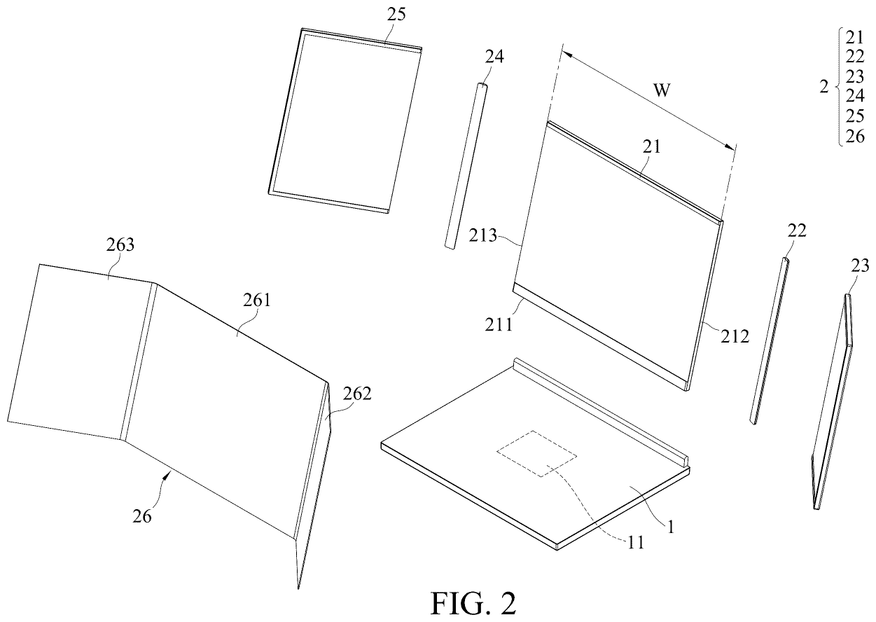

Referring to FIG. 1 and FIG. 2, a foldable electronic apparatus 1000 of the present disclosure comprises a base unit 1 and a display unit 2. The display unit 2 is connected to the base unit 1. The structure of each element and the connection relationship between elements will be described in detail below.

The base unit 1 is provided on a work surface 2000 (such as a desktop) and has a processor 11 for receiving a detection result and sending a signal according to the detection result.

The display unit 2 includes a main panel body 21, a first folding module 22, a first side panel body 23, a second folding module 24, a second side panel body 25 and a flexible screen 26. The main panel body 21 is generally a square panel body and has a bottom side 211, a first side 212 and a second side 213. The bottom side 211 is connected to the base unit 1 and has a width W. The first side 212 and the second side 213 correspond to each other and are perpendicular to the bottom side 211 respectively.

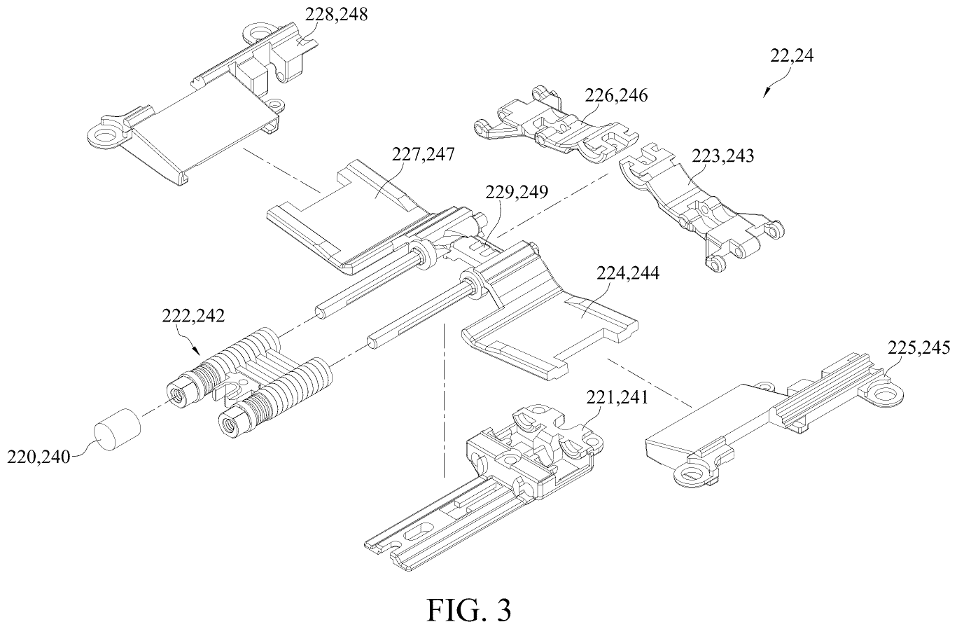

Referring to FIG. 3, the first folding module 22 is provided on the first side 212 and has a first encoding unit 220, a central base 221, a torque member 222, a left wing member 223, a left transmission member 224, a left carrying member 225, a right wing member 226, a right transmission member 227, a right carrying member 228 and a synchronization member 229.

The central base 221 is in a shape of a long block, and an extending direction thereof is parallel to an extending direction of the first side 212. The torque member 222 is provided on the central base 221 for constantly providing an elastic force. One end of the left wing member 223 is pivotally connected to one side of the central base 221. The left transmission member 224 is pivotally connected to the torque member 222 and the central base 221. The left carrying member 225 is pivotally connected to the other end of the left wing member 223 and is connected to the first side 212 of the main panel body 21, and allows the left transmission member 224 to be partially slid therein. One end of the right wing member 226 is pivotally connected to the other side of the central base 221. The right transmission member 227 is pivotally connected to the torque member 222 and the central base 221 and is spaced apart from the left transmission member 224. The right carrying member 228 is pivotally connected to the other end of the right wing member 226 and allows the right transmission member 227 to be partially slid therein. The synchronization member 229 is slidably disposed between the left transmission member 224 and the right transmission member 227 and on the central base 221 to allow the left transmission member 224 and the right transmission member 227 to synchronously and reversely rotate, and at the same time, frictions are generated between the left transmission member 224, the right transmission member 227 and the synchronization member 229. The first encoding unit 220 is provided on the right transmission member 227 and is electrically connected to the processor 11.

In one embodiment, the first encoding unit 220 is an angle encoder, an axis encoder, or a rotary encoder, for detecting a rotation angle of the right transmission member 227 and generating a detection result (i.e., a degree of the rotation angle). The detection result can be transmitted by the first encoding unit 220 to the processor 11 for processing.

In other embodiments, the first folding module 22 may have another set of the first encoding unit 220, the central base 221, the torque member 222, the left wing member 223, the left transmission member 224, the left carrying member 225, the right wing member 226, the right transmission member 227, the right carrying member 228 and the synchronization member 229, which are spaced apart from each other and disposed reversely and symmetrically along the extension direction of the first side 212 (in this case, the right carrying member 228 can be connected to the first side 212 of the main panel body 21), but the present disclosure is not limited to as such. The first folding module 22 can also be two or more sets.

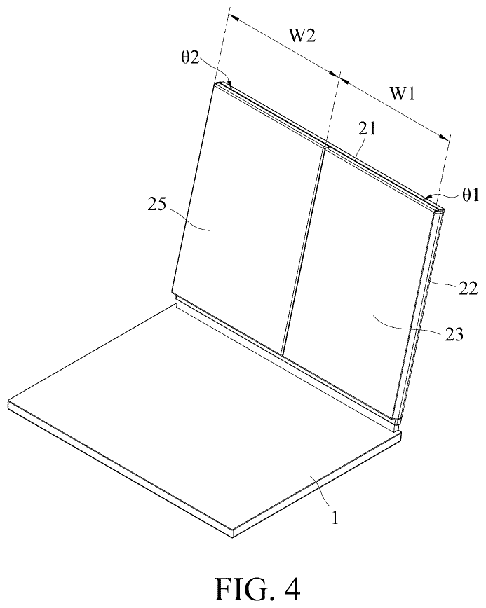

The first side panel body 23 is generally a square panel body and is disposed on the right carrying member 228 of the first folding module 22 (when the right carrying member 228 is connected to the first side 212, the first side panel body 23 is disposed on the left carrying member 225), and the first side panel body 23 can be rotated relative to the main panel body 21 about the first folding module 22 as an axis, and has a width W1 (FIG. 4). The second folding module 24 is disposed on the second side 213 and has a second encoding unit 240, a central base 241, a torque member 242, a left wing member 243, a left transmission member 244, a left carrying member 245, a right wing member 246, a right transmission member 247, a right carrying member 248 and a synchronization member 249, and the structure, quantity and arrangement thereof are the same as those of the first folding module 22, and will not be described again here. The second side panel body 25 is generally a square panel body, is provided on the second folding module 24 and capable of rotating relative to the main panel body 21 about the second folding module 24 as an axis, and has a width W2 (FIG. 4). In an embodiment, the width W of the main panel body 21 is equal to a sum of the width W1 of the first side panel body 23 and the width W2 of the second side panel body 25, and the width W1 is equal to the width W2, but the present disclosure is not limited to as such. The width W1 may not be equal to the width W2.

The flexible screen 26 is provided on the main panel body 21, the first folding module 22, the first side panel body 23, the second folding module 24 and the second side panel body 25, and the flexible screen 26 includes a main display area 261, a first side display area 262 and a second side display area 263. The main display area 261 corresponds to the main panel body 21, the first side display area 262 corresponds to the first side panel body 23, and the second side display area 263 corresponds to the second side panel body 25.

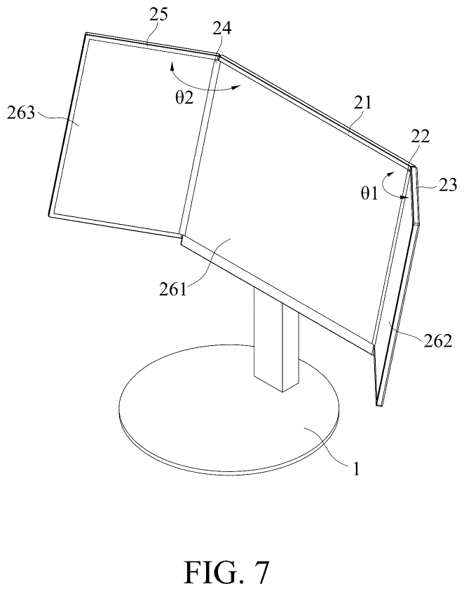

In one embodiment, when the base unit 1 is an external keyboard, the display unit 2 may be a folding tablet computer assembled with or disassembled from the external keyboard, but the present disclosure is not limited to as such. When the base unit 1 is a laptop host, the display unit 2 may be a display screen. In other embodiments, as shown in FIG. 7, the base unit 1 may also be a screen support frame for supporting a display unit 2 such as a display screen or a folding tablet computer.

The following describes the operation of the foldable electronic apparatus 1000 of the present disclosure. Since the first side panel body 23 can be rotated relative to the main panel body 21 about the first folding module 22 as the axis, the left transmission member 224 and the right transmission member 227 are synchronously rotated in the reverse direction. The rotation angle of the left transmission member 224 or the right transmission member 227 can be detected by the first encoding unit 220 disposed on the left transmission member 224 or the right transmission member 227, and the rotation angle can correspond to a first angle θ1 between the main panel body 21 and the first side panel body 23. Since the second side panel body 25 can be rotated relative to the main panel body 21 about the second folding module 24 as the axis, the left transmission member 244 and the right transmission member 247 are synchronously rotated in the reverse direction. The rotation angle of the left transmission member 244 or the right transmission member 247 can be detected by the second encoding unit 240 disposed on the left transmission member 244 or the right transmission member 247, and the rotation angle corresponds to a second angle θ2 between the main panel body 21 and the second side panel body 25. The first angle θ1 and the second angle θ2 can be transmitted to the processor 11, and the display states of the main display area 261, the first side display area 262 and the second side display area 263 can be switched by the processor 11 according to the first angle θ1 and the second angle θ2.

As shown in FIG. 4, when the main panel body 21 is in a display state of being on and the first side panel body 23 and the second side panel body 25 are in a folded state, the main panel body 21 is pivotally connected to the base unit 1 at an angle (i.e., an inner angle sandwiched between them is, for example, 120 degrees), the first side panel body 23 and the main panel body 21 are stacked on each other, and the second side panel body 25 and the main panel body 21 are stacked on each other and side by side with the first side panel body 23. That is, the first angle θ1 between the first side panel body 23 and the main panel body 21 is 0 degrees, and the second angle θ2 between the second side panel body 25 and the main panel body 21 is 0 degrees. At this time, a signal allowing the main display area 261, the first side display area 262 and the second side display area 263 to be in a display state of being off can be transmitted by the processor 11.

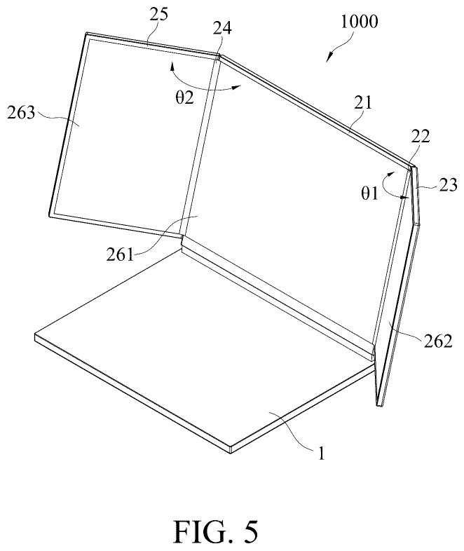

As shown in FIG. 5, when the main panel body 21 is in a display state of being on and the first side panel body 23 and the second side panel body 25 are in a semi-open state, the display states of the main display area 261, the first side display area 262 and the second side display area 263 can be switched by the processor 11 according to the first angle θ1 and the second angle θ2. For example, when the first angle θ1 and the second angle θ2 are both about 95 degrees, the main display area 261 is in the open state, and the first side display area 262 and the second side display area 263 may be in a display state of being off. For another example, when the first angle θ1 and the second angle θ2 are both about 135 degrees, the main display area 261, the first side display area 262 and the second side display area 263 are all in the open state, and at this time, different program images can be displayed on the main display area 261, the first side display area 262 and the second side display area 263 respectively.

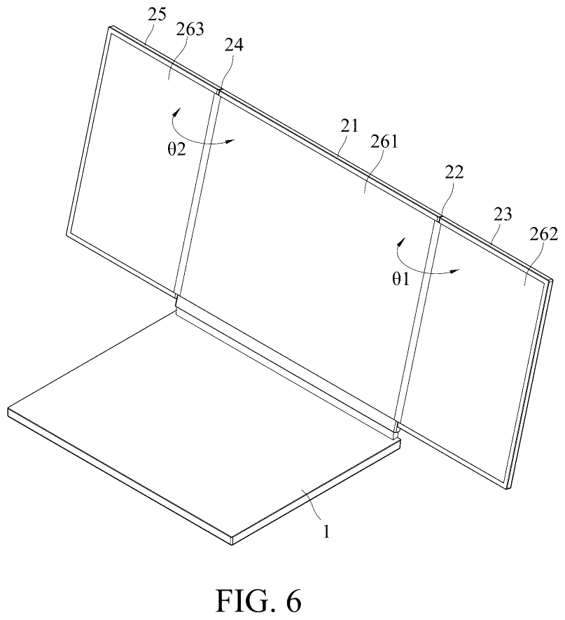

As shown in FIG. 6, when the main panel body 21 is in a display state of being on and the first side panel body 23 and the second side panel body 25 are in a fully open state, (i.e., the first angle θ1 and the second angle θ2 are both about 180 degrees), the states of the main display area 261, the first side display area 262 and the second side display area 263 can be switched to the open state by the processor 11 according to the first angle θ1 and the second angle θ2, and the continuous image of the same program can be displayed on the main display area 261, the first side display area 262 and the second side display area 263.

The aforementioned values of the first angle θ1 and the second angle θ2 and the corresponding display states of the main display area 261, the first side display area 262 and the second side display area 263 are only examples, and the present disclosure is not limited to as such. The user can set the values of the first angle θ1 and the second angle θ2 and the corresponding display states of the main display area 261, the first side display area 262 and the second side display area 263 through a program.

A single first encoding unit 220 and a single second encoding unit 240 are described above as an example. However, two first encoding units 220 can also be provided on the left transmission member 224 and the right transmission member 227, respectively (that is, they are respectively sleeved on the rods), and two second encoding units 240 can be provided on the left transmission member 244 and the right transmission member 247, respectively. In this case, the sum of the rotation angles of the left transmission member 224 and the right transmission member 227 detected by the two first encoding units 220 is the first angle θ1 (the rotation angle detected by a single first encoding unit 220 is approximately half of the first angle θ1), the sum of the rotation angles of the left transmission member 244 and the right transmission member 247 detected by the two second encoding units 240 is the second angle θ2 (the rotation angle detected by a single second encoding unit 240 is approximately half of the second angle θ2).

In view of the above, the foldable electronic apparatus of the present disclosure is capable of detecting the folding conditions of the first side panel body and the second side panel body relative to the main panel body by the first encoding unit and the second encoding unit, respectively, and can be automatically switched between different display states according to different angles without switching through a keyboard or other controllers, which is convenient to use and provides a good using experience.

What is claimed is:

1. A foldable electronic apparatus, provided on a work surface, the foldable electronic apparatus comprising:
a base unit provided on the work surface; and
a display unit including:
a main panel body having a first side and a bottom side substantially perpendicular to each other, wherein the bottom side is connected to the base unit;
a first folding module provided on the first side and having at least one first encoding unit;
a first side panel body provided on the first folding module and capable of rotating relative to the main panel body about the first folding module as an axis; and
a flexible screen provided on the main panel body, the first folding module and the first side panel body and including a main display area and a first side display area, wherein the main display area corresponds to the main panel body, and the first side display area corresponds to the first side panel body,
wherein the first encoding unit is used to detect a first angle between the main panel body and the first side panel body, and display states of the main display area and the first side display area are switched according to the first angle.

2. The foldable electronic apparatus of claim 1, wherein the display unit further includes a second folding module and a second side panel body, the main panel body further has a second side opposite to the first side, and the second folding module is provided on the second side and has at least one second encoding unit, wherein the second side panel body is provided on the second folding module and capable of rotating relative to the main panel body about the second folding module as an axis, wherein the flexible screen further includes a second side display area, and the second side display area corresponds to the second side panel body, and wherein the second encoding unit is used to detect a second angle between the main panel body and the second side panel body, and display states of the main display area and the second side display area are switched according to the second angle.

3. The foldable electronic apparatus of claim 2, wherein the main display area, the first side display area and the second side display area are in a display state of being off when the first angle and the second angle are both 0 degree.

4. The foldable electronic apparatus of claim 2, wherein the main display area is in a display state of being on and the first side display area and the second side display area are in a display state of being off when the first angle and the second angle are both about 95 degrees.

5. The foldable electronic apparatus of claim 2, wherein the main display area, the first side display area and the second side display area are in a display state of being on and capable of displaying different program images respectively when the first angle and the second angle are both about 135 degrees.

6. The foldable electronic apparatus of claim 2, wherein the main display area, the first side display area and the second side display area are in a display state of being on and capable of displaying continuous images of a same program when the first angle and the second angle are both about 180 degrees.

7. The foldable electronic apparatus of claim 2, wherein the first encoding unit and the second encoding unit are angle encoders, axis encoders, or rotary encoders.

8. The foldable electronic apparatus of claim 7, wherein the base unit has a processor, and the first encoding unit and the second encoding unit respectively transmit detection results of the first angle and the second angle to the processor.

9. The foldable electronic apparatus of claim 8, wherein the base unit is a detachable external keyboard when the display unit is a foldable tablet computer, and the base unit is a laptop host or a screen support frame when the display unit is a display screen.

10. The foldable electronic apparatus of claim 9, wherein the first folding module or the second folding module further has a central base, a torque member, a left wing member, a left transmission member, a left carrying member, a right wing member, a right transmission member, a right carrying member and a synchronization member, and wherein the first encoding unit or the second encoding unit is provided on the left transmission member or the right transmission member.

11. The foldable electronic apparatus of claim 10, wherein a width of the main panel body is equal to a sum of a width of the first side panel body and a width of the second side panel body.
